(19) United States
(12) Patent Application Publication
(10) Pub. No.: US 2023/0042851 A1
(43) Pub. Date: Feb. 9, 2023

(54) CONNECTION TERMINAL

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); MITSUBISHI MATERIALS CORPORATION, Tokyo (JP)

(72) Inventors: Toshiro SAKAI, Yokkaichi-shi (JP); Kingo FURUKAWA, Yokkaichi-shi (JP); Takeshi MASUDA, Yokkaichi-shi (JP); Tetsuya KUWABARA, Osaka-shi (JP); Michio TAKASAKI, Sakai City (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); MITSUBISHI MATERIALS CORPORATION, Tokyo (JP)

(21) Appl. No.: 17/789,716

(22) PCT Filed: Jan. 12, 2021
(86) PCT No.: PCT/JP2021/000601

§ 371 Date: Jun. 28, 2022

(30) Foreign Application Priority Data
Jan. 14, 2020 (JP) 2020-003712

(51) Int. Cl. C22C 9/04; C22F 1/08; H01R 13/03; H01R 13/11

(52) U.S. Cl. CPC C22C 9/04; C22F 1/08; H01R 13/03; H01R 13/113

(57) ABSTRACT

A connection terminal having a copper alloy as a base material, the copper alloy comprising Zn in an amount of 21 mass % or more and 27 mass % or less, Sn in an amount of 0.6 mass % or more and 0.9 mass % or less, Ni in an amount of 2.5 mass % or more and 3.7 mass % or less, and P in an amount of 0.01 mass % or more and 0.03 mass % or less, and the balance being Cu and inevitable impurities, wherein the copper alloy has: a 0.2% proof stress of 620 MPa or higher and 700 MPa or lower, and an electrical conductivity of 15% IACS or higher and 20% IACS or lower.

### TECHNICAL FIELD

The present disclosure relates to a connection terminal.

### BACKGROUND ART

Conventionally, copper and a copper alloy have usually been used as a base material constituting a connection terminal used for electrical connections in automotive interiors or the like. Specifically, solid solution strengthened copper alloys such as brass and phosphor bronze are widely used.

In recent years, a reduction in the size of connection terminals has been achieved along with a reduction in the weight of automobiles and improvement in electronic control. In order to maintain sufficient electrical conductivity when reducing the size of a connection terminal, a spring portion constituting a contact portion needs to have high stress resistance. Furthermore, in order to form such a material having high stress resistance into a small connection terminal, the material needs to have high bendability. Also, if a connection terminal is used in a high temperature environment such as a surrounding region of the engine compartment of an automobile, the constituent material of the connection terminal needs to have high stress relaxation resistance in order to avoid a decrease in the elastic force of the spring portion constituting a contact portion due to a stress relaxation phenomenon.

The above brass and phosphor bronze do not have sufficiently high stress resistance, bendability, or stress relaxation resistance suitable for reducing the size of connection terminals. In view of this, a Corson alloy (Cu—Ni—Si-based alloy) may be used as a copper alloy which is a precipitation strengthened copper alloy that has high stress resistance, bendability, and stress relaxation resistance, to form a connection terminal. PTL1 discloses a Corson alloy used in electric and electronic components such as automotive connectors, for example. This Corson alloy has low strength anisotropy and high bendability.

### CITATION LIST

### Patent Literature

PTL1: JP 2011-162848 A
PTL2: WO 2015/046470
PTL3: WO 2015/046421
PTL4: JP 2013-213237 A
PTL5: JP 2009-185341 A
Non-Patent Literature 1: R. Labusch, “A Statistical Theory of Solid Solution Hardening”, Physica Status Solidi, 1970, vol. 41, pp. 659-669

### SUMMARY OF INVENTION

### Technical Problem

As described above, if a Corson alloy is used as a base material of a connection terminal, high stress resistance, bendability, and stress relaxation resistance, which are required accompanying a reduction in the size of the connection terminal, can be utilized. However, as described in PTL1 as well, precipitation strengthened alloys such as a Corson alloy require treatment steps such as a solution treatment and aging treatment when a terminal connection is manufactured. Thus, a precipitation strengthened alloy is more expensive than a solid solution strengthened alloy. Therefore, if a Corson alloy is used as a base material of a connection terminal, material costs of the connection terminal will increase.

In view of this, an aim of this disclosure is to provide a connection terminal in which a copper alloy that has high stress resistance, bendability, and stress relaxation resistance and can be manufactured at low costs is used as a base material.

### Solution to Problem

A connection terminal according to this disclosure comprises a copper alloy as a base material that comprises Zn in an amount of 21 mass % or more and 27 mass % or less; Sn in an amount of 0.6 mass % or more and 0.9 mass % or less; Ni in an amount of 2.5 mass % or more and 3.7 mass % or less; and P in an amount of 0.01 mass % or more and 0.03 mass % or less, and the balance comprises Cu and inevitable impurities, and the copper alloy has a 0.2% proof stress of 620 MPa or higher and 700 MPa or lower and has an electrical conductivity of 15% IACS or higher and 20% IACS or lower.

### Advantageous Effects of Invention

As described above, the base material constituting the connection terminal according to this disclosure has a predetermined component composition and a 0.2% proof stress within a predetermined range. As a result, the base material has high stress resistance, bendability, and stress relaxation resistance. Also, these copper alloys are solid solution strengthened alloys, and can be manufactured without including treatment steps that increase material costs, such as solution treatment and age-hardening treatment. Furthermore, these copper alloys comprise a large amount of Zn, which is a comparatively inexpensive element, and the Cu content, the Sn content, and the Ni content in these copper alloys are low. Therefore, the base material can be manufactured at low costs.

### BRIEF DESCRIPTION OF DRAWINGS

FIG. 1 is a cross-sectional view showing a configuration of a female terminal as a connection terminal according to one embodiment of this disclosure.

FIG. 2 is an enlarged perspective view showing a bent portion of an elastic contact piece in the connection terminal shown in FIG. 1.

FIG. 3A is a diagram showing a relationship of solid solution strengthening index τₛ with 0.2% proof stress and electrical conductivity, with regard to each sample in examples.

FIG. 3B is an enlarged view illustrating a portion shown in FIG. 3A.

### DESCRIPTION OF EMBODIMENTS

### Description of Embodiments of the Present Disclosure

First, embodiments according to this disclosure will be listed and described.

A connection terminal according to an embodiment of this disclosure comprises a copper alloy as a base material, the copper alloy comprises Zn in an amount of 21 mass % or more and 27 mass % or less, Sn in an amount of 0.6 mass % or more and 0.9 mass % or less, Ni in an amount of 2.5 mass % or more and 3.7 mass % or less, and P in an amount of 0.01 mass % or more and 0.03 mass % or less, and the balance comprises Cu and inevitable impurities, wherein the copper alloy has a 0.2% proof stress of 620 MPa or higher and 700 MPa or lower and an electrical conductivity of 15% IACS or higher and 20% IACS or lower.

The base material constituting the connection terminal according to the above embodiment is made of a copper alloy comprising Zn, Sn, Ni, and P in the corresponding predetermined amounts. A copper alloy having such a component composition tends to exhibit high stress resistance, high bendability, and high stress relaxation resistance. In particular, when a copper alloy has a 0.2% proof stress of 620 MPa or higher, the copper alloy exhibits sufficient springiness required for small connection terminals. On the other hand, when the 0.2% proof stress of the base material is reduced to 700 MPa or lower, bendability required for forming the connection terminals is ensured.

Also, the copper alloy constituting the base material comprises Zn, which is a comparatively inexpensive element, in an amount of 21 mass % or more, and thus, the amounts of Cu, Sn, and Ni, which are comparatively expensive elements, in the copper alloy, are kept small. Therefore, the material costs of the base material are reduced. Furthermore, this copper alloy is a solid solution strengthened alloy, and thus, unlike the precipitation strengthened alloy such as a Corson alloy, this copper alloy can be manufactured without including treatment steps that increase processing costs, such as solution treatment and age-hardening treatment. As a result, the manufacturing cost required for the base material is reduced, and the connection terminal can be manufactured at low costs.

Also, the base material constituting the connection terminal has an electrical conductivity of 15% IACS or higher, and thus resistance heat generation is suppressed and heat resistance is increased, even in a small connection terminal. On the other hand, when the electrical conductivity is reduced to 20% IACS or lower, the concentration of Zn in the copper alloy can be increased, and the manufacturing cost required for the base material can be effectively reduced.

With the connection terminal according to the above embodiment, the solid solution strengthening index τₛ preferably satisfies 60≤τₛ≤75. As a result, the base material tends to have sufficient proof stress required for a small connection terminal, and to have bendability required for forming a connection terminal.

Furthermore, the connection terminal according to the above embodiment may have the following configuration. First, the copper alloy may have an average grain size of 2.0 μm or larger and 5.0 μm or smaller. In this case, the base material will have proof stress, ductility, and stress relaxation resistance in a well-balanced manner.

Also, the copper alloy preferably further comprise Fe in an amount of 0.02 mass % or less. In the copper alloy, Fe has effects such as a solid solution strengthening effect.

The copper alloy preferably further comprise at least one selected from the group consisting of Co, Cr, Zr, Ti, Mn, and V in a total amount of 0.1 mass % or less. These elements exhibit the effects of improving the strength and the stress relaxation resistance of the copper alloy.

The copper alloy preferably have a 0.2% proof stress of 620 MPa or higher and 700 MPa or lower in a direction perpendicular to a rolling direction. When a base material is manufactured by rolling a copper alloy, the 0.2% proof stress in the direction perpendicular to the rolling direction can be adjusted more easily according to rolling conditions. Thus, by adjusting conditions under which the base material is manufactured, the base material tends to have 0.2% proof stress in a predetermined range in the direction perpendicular to the rolling direction.

The connection terminal may include a spring portion where the copper alloy in the form of a plate is bent in a direction perpendicular to the rolling direction, in a region that includes a contact portion that makes electrical contact with a counterpart electrical contact. The proof stress in the direction perpendicular to the rolling direction can be increased by rolling the copper alloy, and thus the spring portion tends to apply high contact pressure at the contact portion. Because high contact pressure is exerted by the spring portion, a stable electrical connection is formed between the contact portion provided in the spring portion and the counterpart electrical contact.

The connection terminal is may be a female terminal. The female terminal has a structure for generating contact pressure, such as a spring portion, and thus maintains an electrical connection between terminals by applying the contact pressure to the counterpart male terminal. Therefore, as a result of the base material of the female terminal being made of the copper alloy having a high stress resistance of 0.2% proof stress, the female terminal can ensure a stable electrical connection. Although the female terminal has a more complex shape than the male terminal, the female terminal can be easily manufactured because the copper alloy has high bendability.

A tab width, which is defined as the width of a tab of a mating counterpart male terminal if the connection terminal is a female terminal, and which is defined as the width of the tab of a male terminal if the connection terminal is the male terminal, is preferably 0.5 mm or smaller. When a base material is constituted by a copper alloy with a high stress resistance, even in a small connection terminal having such a small tab width, it is possible to ensure stable electrical conductivity of the contact portion between the connection terminal and the counterpart electrical contact.

The copper alloy preferably constitute the connection terminal in the form of a plate with a plate thickness of 0.20 mm or smaller. When a base material is constituted by the above copper alloy with a high stress resistance, even in a small connection terminal constituted by such a base material with a small plate thickness, it is also possible to ensure stable electrical conductivity.

### Details of Embodiments of the Present Disclosure

A connection terminal according to an embodiment of this disclosure will be described below in detail with reference to the drawings. A connection terminal according to an embodiment of this disclosure comprises a copper alloy as a base material that has a predetermined component composition and physical properties.

Hereinafter, units of the content of each element in an alloy composition are in mass % in this specification. Each physical property value refers to a value measured in an atmosphere at room temperature, unless otherwise specified. Also, concepts indicating the shape and arrangement of members, such as parallel and perpendicular, include not only geometrically strict concepts but also deviations of an allowable degree as a connection terminal.

<Structure of Connection Terminal>

First, an overview of a structure of a connection terminal according to an embodiment of this disclosure will be described. Although there is no particular limitation on specific shapes and applications of the connection terminal according to an embodiment of this disclosure, a structure of a mating female terminal 10 will be briefly described below as an example.

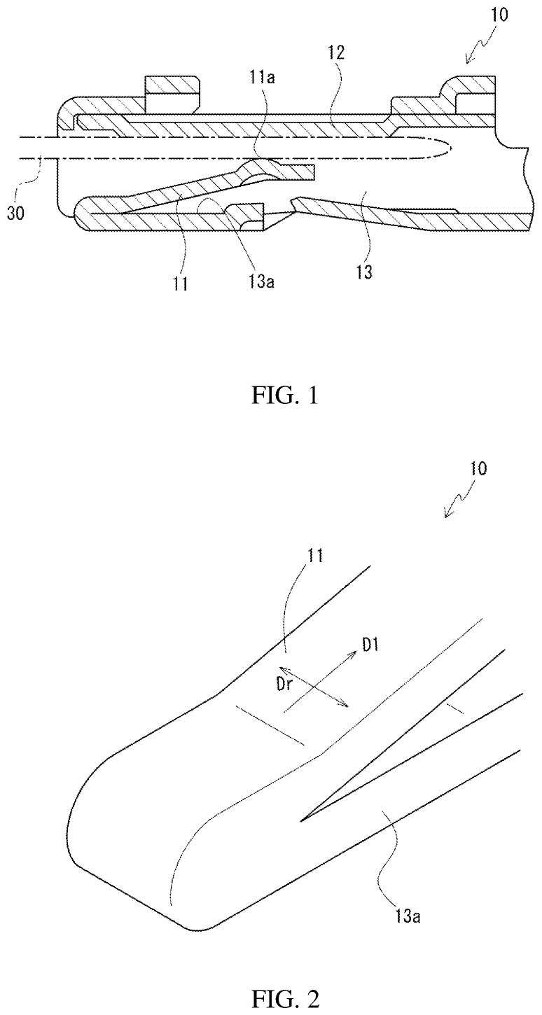

FIG. 1 shows a schematic structure of the female terminal 10. The female terminal 10 has a shape that is similar to that of a known mating female terminal. That is, a pressing portion 13 is formed in a rectangular cylindrical shape with a forward opening, and has, as a spring portion, an elastic contact piece 11 having a shape in which the contact piece is folded inwardly to the rear inside a bottom surface 13a of the pressing portion 13. When a flat-plate shaped tab of the male terminal 30 is inserted as a counterpart electrical connection member into the pressing portion 13 of the female terminal 10, the elastic contact piece 11 of the female terminal 10 makes contact with the male terminal 30 at an embossed portion 11a that bulges inward into the pressing portion 13, and applies an upward force to the male terminal 30. The surface of a ceiling portion of the pressing portion 13 that faces the elastic contact piece 11 serves as an inner facing contact surface 12, and the male terminal 30 is pressed and held inside the pressing portion 13 as a result of the male terminal 30 being pressed against the inwardly facing contact face 12 by the elastic contact piece 11.

The female terminal 10 is formed by using a copper alloy according to the later-described first or second form as the base material. In order to prevent deformation of a base material, such as oxidation, a coating layer for improving surface properties such as electrical conductivity and frictional properties may be formed on the surface of the base material as appropriate. There is no particular limitation on the composition of the coating layer as long as the coating layer is thinner than the base material, and examples thereof include a layer that comprises a metal with a composition that is different from that of the base material and a layer that comprises an organic compound. The coating layer may be formed by forming only one layer or multiple types of layers are laminated on the surface of the base material. Examples of the coating layer include a metal layer such as a tin plating layer and a lubricant layer.

There is no particular limitation on a direction of the base material constituting the female terminal 10, and a direction perpendicular to a rolling direction Dr of the base material is preferably a bending direction D1 of the elastic contact piece 11. That is, as shown in the enlarged view in FIG. 2, the bending direction D1, which is a direction in which the elastic contact piece 11 is bent from the bottom surface 13a of the pressing portion 13, is perpendicular to the rolling direction Dr of the base material. The rolling direction Dr of the base material can be discriminated based on a linear design that is obtained by transferring the surface property of a rolling roll called rolling line and that extends in the rolling direction.

Although there is no particular limitation on the size of the female terminal 10, the female terminal 10 is preferably small, from the viewpoint of effectively utilizing the later-described properties of the base material. The tab width is preferably 0.5 mm or smaller, for example. Here, the tab width of the female terminal 10 refers to the width of a tab of the counterpart male terminal 30 that is capable of being mated with the female terminal 10. Also, the copper alloy base material constituting the female terminal 10 preferably has a plate thickness of 0.20 mm or smaller.

The connection terminal according to an embodiment of this disclosure is not limited to a mating female terminal 10 as described above, and may have any form such as the male terminal 30. Various terminals can be formed using a copper alloy, which will be described later, as a base material. However, from the viewpoint of effectively utilizing the later-described properties of the base material, such as excellent stress resistance and bendability, similar to the elastic contact piece 11 of the female terminal 10, the connection terminal preferably has, in a region that includes the contact portion (the embossed portion 11a in the above description), a structure by which contact pressure can be applied to the contact portion due to the elasticity of the spring portion, that is, the base material.

Furthermore, the bending direction D1 of the spring portion included in the connection terminal is preferably perpendicular to the rolling direction Dr of the copper alloy base material. Even if the connection terminal does not have a spring portion, when the connection terminal has a portion to which 180° bending is applied, the bending direction in which the portion is bent is preferably perpendicular to the rolling direction Dr of the base material. Here, 180° bending refers to bending such that the plate surfaces of the folded base material face each other in parallel. The elastic contact piece 11 of the female terminal 10 is folded rearward through 180° bending from the bottom surface 13a of the pressing portion 13.

Furthermore, even when the connection terminal according to an embodiment of this disclosure has a shape other than the shape of the female terminal 10, the copper alloy preferably constitutes the connection terminal in the form of a plate with a plate thickness of 0.20 mm or smaller. Also, similarly to the case where the connection terminal is the female terminal 10, if the connection terminal is a mating male terminal 30, the tab width (the width of the tab of the male terminal 30) is preferably 0.5 mm or smaller. Even when the connection terminal has a shape other than the shapes of the mating female terminal 10 and the male terminal 30, the horizontal width of a plate-shaped portion that includes the contact portion is preferably 0.5 mm or smaller.

<Copper Alloy Constituting Base Material>

Next, a copper alloy, which is a base material of the connection terminal according to an embodiment of this disclosure, will be described.

(1) Copper Alloy According to First Form

A copper alloy according to a first form that constitutes the connection terminal according to an embodiment of this disclosure comprises the following additive elements, and the balance comprises Cu and inevitable impurities.

21 mass %≤Zn≤27 mass %

0.6 mass %≤Sn≤0.9 mass %

2.5 mass %≤Ni≤3.7 mass %

0.01 mass %≤P≤0.03 mass %

Also, the copper alloy according to this form has a 0.2% proof stress of 620 MPa or higher and 700 MPa or lower, and an electrical conductivity of 15% IACS or higher and 20% IACS or lower. The following describes the component composition and properties of this copper alloy in detail.

(Component Composition)

The copper alloy according to the first form comprises Zn, Sn, Ni, and P as essential additive elements, and the balance comprises Cu and inevitable impurities. The following describes the content of each additive element and effects thereof, and the like.

(1) 21 Mass %≤Zn≤27 Mass %

Zn is dissolved in a copper matrix phase to form a solid solution and causes solid solution strengthening. Much of Zn added to the copper alloy can be dissolved in the copper matrix phase so as to form a solid solution. Also, Zn is more inexpensive than Cu, and material costs of a copper alloy obtained by adding a large amount of Zn to a Cu alloy can be reduced.

By setting the Zn content to 21 mass % or more, the extent of solid solution strengthening is increased, and high strength required for a connection terminal can be easily obtained. Also, crystal grains can be refined more easily, and high bendability can be obtained. The effect of reducing material costs is also improved by adding Zn. From the viewpoint of further improving these effects, the Zn content is more preferably 22 mass % or more.

On the other hand, if the Zn content is excessively high, the β phase may be formed in the copper alloy, and ductility and stress corrosion cracking resistance will be significantly reduced. Furthermore, if the Zn content is excessively high, the Young's modulus of the copper alloy will decrease, and the stacking-fault energy will also decrease. Then, stress corrosion cracking resistance will also decrease. Furthermore, Zn has a high diffusion rate, and thus stress relaxation resistance also decreases. In view of this, by setting the Zn content to 27 mass % or less, it is possible to avoid these situations, and to obtain a copper alloy having ductility, stress corrosion cracking resistance, and electrical conductivity in a well-balanced manner. From the viewpoint of keeping ductility and stress corrosion cracking resistance high in particular, the Zn content is more preferably 26 mass % or less.

(2) 0.6 Mass %≤Sn≤0.9 Mass %

Similarly to Zn, Sn is an element that is dissolved in the copper matrix phase so as to forma solid solution and causes solid solution strengthening, and the strength, stress relaxation resistance, and stress corrosion cracking resistance of the copper alloy can be improved through addition of Sn. Also, it is possible to refine crystal grains through addition of Sn, and to improve the strength and bendability of the copper alloy by refining the crystal grains.

It is possible to effectively obtain the above effects of Sn addition by setting the Sn content to 0.6 mass % or more. From the viewpoint of obtaining these effects more remarkably, the Sn content is more preferably 0.7 mass % or more.

On the other hand, if the copper alloy comprises a large amount of Sn, the electrical conductivity and the Young's modulus of the copper alloy will rapidly deteriorate. Also, adding an excessive amount of Sn thereto will increase material costs and reduce hot workability, resulting in an increase in the manufacturing cost required for the base material. High electrical conductivity can be maintained and the manufacturing cost required for the base material can be reduced by setting the Sn content to 0.9 mass % or less, and preferably to 0.8 mass % or less.

(3) 2.5 Mass %≤Ni≤3.7 Mass %

Ni is dissolved in the copper matrix phase to form a solid solution and slightly causes solid solution strengthening. Also, as described above, due to Zn and Sn being added to the copper alloy, the Young's modulus and stacking-fault energy tend to decrease. However, addition of Ni to the copper alloy makes it possible to keep the Young's modulus and stacking-fault energy from decreasing. As a result, it is possible to ensure springiness required for the base material of the connection terminal and to suppress deterioration of stress corrosion cracking resistance. Also, Ni has a low diffusion rate, and thus stress relaxation resistance can be improved. Furthermore, when Ni is added to the copper alloy with P, Ni—P-based precipitates form, and strength can be improved through dispersion and precipitation strengthening, and it is possible to obtain the effect of refining crystal grains by pinning grain boundaries. Also, Ni has the effects of forming a Cottrel atmosphere and significantly improving stress relaxation resistance due to high affinity with P dissolved in the copper alloy to form a solid solution. It is possible to effectively obtain the above effects of added Ni by setting the Ni content to 2.5 mass % or more, and preferably to 2.6 mass % or more.

On the other hand, Ni is an expensive element, and if a large amount of Ni is added, material costs will increase. Also, even if a large amount of Ni is added, the effects of added Ni, such as improvement of stress relaxation properties, will be saturated. In view of this, material costs can be reduced by setting the Ni content to 3.7 mass % or less. The Ni content is more preferably 3.6 mass % or less.

(4) 0.01 Mass %≤P≤0.03 Mass %

As described above, Furthermore, when P is added to the copper alloy with Ni, Ni—P-based precipitates form, and it is possible to obtain the effects of dispersion and precipitation strengthening and the effect of refining crystal grains. Also, P can improve stress relaxation resistance due to high affinity with Ni dissolved to form a solid solution. These effects can be effectively obtained by setting the P content to 0.01 mass % or more.

On the other hand, if the amount of P that forms a solid solution increases, the electrical conductivity of the copper alloy will significantly decrease. Also, coarse Ni—P-based precipitates will form, and bendability will also deteriorate. The electrical conductivity and bendability of the copper alloy can be ensured by setting the P content to 0.03 mass % or less.

In addition to Zn, Sn, Ni, and P, which are the above-described essential elements, this copper alloy may optionally comprise one or two or higher types of elements selected from the following elements. The following describes the content of optional additive elements and effects thereof, and the like.

(5) Fe≤0.02 Mass %

Fe causes solid solution strengthening in the copper alloy, and has the effects of facilitating deoxidation during casting and refining the cast structure. Also, the formation of Ni—Fe—P-based precipitates achieves the effect of dispersion and precipitation strengthening, and the effect of refining crystal grains through a pinning phenomenon when the copper alloy is recrystallized. Because Fe can greatly exhibit these effects by adding a little amount of Fe to the copper alloy, there is no particular limitation on the lower limit of the content thereof, and the lower limit of the Fe content can be 0.001 mass % or more, for example.

On the other hand, if the Fe content is excessively high, coarse Ni—Fe—P precipitates will form, and the bendability of the copper alloy will deteriorate. From the viewpoint of ensuring bendability, the Fe content is set to 0.02 mass % or less.

(6) Co, Cr, Zr, Ti, Mn, and V≤0.1 Mass %

The effects of improving the strength and the stress relaxation resistance of the copper alloy can be obtained by adding at least one of Co, Cr, Zr, Ti, Mn, and V to the copper alloy. Because these elements greatly exhibit these effects by adding a little amount of the elements to the copper alloy, there is no particular limitation on the lower limit of the content thereof, and the lower limit thereof can be 0.001 mass % or more, for example.

On the other hand, if the content of these elements (M) is excessively high, Ni-M-P-based precipitates and M-P-based precipitates will form, and the bendability of the copper alloy will deteriorate. From the viewpoint of ensuring bendability, the content of these elements is set to 0.1 mass % or less in total.

(7) Inevitable Impurities

This copper alloy comprises the above predetermined amounts of Zn, Sn, Ni, and P as essential additive elements, and comprises the optional additive elements as needed, and the balance comprises Cu and inevitable impurities. Here, examples of the inevitable impurities include O, H, C, and S. Specific examples of the inevitable impurities that include O, H, C, and S include H₂O or the like.

(8) Relationship Between Zn, Sn, and Ni Contents

It is preferable that the Zn content, the Sn content, and the Ni content in this copper alloy respectively satisfy the above content ranges and satisfy a relationship described below.

The 0.2% proof stress of a copper alloy can be increased by increasing the degree of processing of the copper alloy. On the other hand, if the degree of processing is increased, the bendability of the copper alloy will deteriorate. Therefore, in order to achieve sufficient 0.2% proof stress and bendability, the extent of strengthening due to the formation of the solid solution of Zn, Sn, and Ni, which are additive elements that cause solid solution strengthening in the copper alloy, needs to be made sufficiently large.

As disclosed in Non-Patent literature 1, basic studies have been conducted on the extent of strengthening due to solute atoms, and it is known that the extent of strengthening is expressed by the following τₘ.

$$[ Mathematical 1 ]$$

$${τ}_{m} = {[ \frac{{F}_{m}^{4} {c}^{2} w}{4 μ {b}^{9}} ]}^{\frac{1}{3}} \qquad ( 1 )$$

where Fₘ represents the interaction force between solute atoms and dislocation, w represents a parameter indicating a range in which dislocation interaction occurs among solute atoms, b represents Burger's vector, c represents the concentration of solute atoms, and p represents shear modulus. Formula (1) indicates that the extent of strengthening due to solute atoms is proportional to the concentration of the solute atoms to the power of ⅔.

As described above, three types of elements Zn, Sn, and Ni contribute to solid solution strengthening in this copper alloy. The inventors of the present invention conducted studies based on the results of experiments with reference to the above Labusch theory, and found that the extent of solid solution strengthening due to three types of elements can be ordered based on the addition law of the concentration of the corresponding solute atoms to the power of ⅔, and the solid solution strengthening index τₛ represented by the following formula can be used as the index of the extent of solid solution strengthening of the copper alloy.

$$[ Mathematical 2 ]$$

$${τ}_{s} = \frac{{164 [ Zn ]}^{\frac{2}{3}} + {858 [ Sn ]}^{\frac{2}{3}} + {45.6 [ Ni ]}^{\frac{2}{3}}}{{( 190 - 0.1 [ Zn ] - 0.9 [ Sn ] + 0.1 [ Ni ] )}^{\frac{2}{3}}} \qquad ( 2 )$$

where [Zn], [Sn], and [Ni] respectively represent the amounts of Zn, Sn, and Ni comprised in the copper alloy in units of mass %.

In this copper alloy, the above solid solution strengthening index τₛ is preferably in the range of 60≤τₛ≤75. As will be described later, as a result of maintaining the solid solution strengthening index Tₛ at 60 or higher, even when the degree of processing is set such that this copper alloy has a 0.2% proof stress of 620 MPa or higher, it is possible to secure bendability to the extent that the base material can be formed into the shape of the connection terminal. From the viewpoint of further improving bendability, the solid solution strengthening index τₛ is preferably 62 or higher, and more preferably 65 or higher.

On the other hand, if the solid solution strengthening index τₛ is excessively large, it is difficult to maintain the electrical conductivity of the copper alloy at 15% IACS or higher. Also, stress relaxation resistance tends to decrease. In view of this, high electrical conductivity and stress relaxation resistance of the copper alloy can be maintained more easily by setting the solid solution strengthening index τₛ to 75 or lower. From the viewpoint of further improving these effects, the solid solution strengthening index τₛ is preferably 70 or lower.

The copper alloy according to this form comprises essential elements such as those described above and comprises optional additive elements as needed, and has the solid solution strengthening index τₛ in a predetermined range. As a result, the copper alloy has high stress resistance, bendability, stress relaxation resistance, and conductivity. Furthermore, this copper alloy also has high stress corrosion cracking resistance. Various properties of the copper alloy will be described later in detail.

Also, the copper alloy according to this form is a solid solution strengthened alloy that comprises additive elements that causes solid solution strengthening, such as Zn, Sn, and Ni. Therefore, unlike precipitation strengthened alloys, strengthening treatment steps such as solution treatment and aging treatment are not required in the manufacturing process. Thus, it is possible to reduce costs required for processing when a base material is manufactured. In addition, this copper alloy comprises Zn, which is an inexpensive element, in a large amount of 21 mass % or more. Because the Zn content is high, the content of expensive elements such as Cu, Sn, and Ni is reduced, and thus material costs decrease. By reducing processing costs and material costs in this manner, it is possible to manufacture the base material constituting a connection terminal at low costs.

(Crystal Structure)

The copper alloy according to this form preferably has an average grain size of 5.0 μm or smaller, and more preferably has an average grain size of 4.5 μm or smaller. The proof stress and ductility of the copper alloy can be improved by refining crystal grains. On the other hand, if crystal grains are refined excessively, grain boundary diffusion will have great influence, and stress relaxation resistance will be reduced. In view of this, from the viewpoint of ensuring stress relaxation resistance, the average grain size is 2.0 μm or larger, and more preferably 2.5 μm or larger. When a copper alloy has an average grain size in a range of 2.0 μm or larger and 5.0 μm or smaller, the copper alloy has proof stress, ductility, and stress relaxation resistance in a well-balanced manner.

The average grain size in the copper alloy can be controlled by a component composition of the copper alloy. Crystal grains can be refined by increasing the content of Zn, Sn, Ni, and P in the above predetermined range and adding at least one of Fe, Co, Cr, Zr, Ti, Mn, and V, which are optional elements, for example. Also, the average grain size also depends on the manufacturing conditions for the copper alloy, and crystal grains can also be refined by increasing the rolling ratio when rolling the copper alloy, for example.

The average grain size in the copper alloy can be evaluated by observing the structure thereof using a scanning electron microscope (SEM), for example. It is sufficient to set an average value of the equivalent circle diameters of crystal grains as the average grain size.

(Properties of Copper Alloy)

The copper alloy according to this form has properties such as the following.

(1) 0.2% Proof Stress

The 0.2% proof stress refers to an amount serving as an index of the strength of a metallic material, and this copper alloy has a 0.2% proof stress of 620 MPa or higher and 700 MPa or lower. The larger the 0.2% proof stress of the base material in the connection terminal is, the easier it is to apply a large contact pressure to the contact portion that is in electrical contact with the counterpart electrical contact. In the case of the above-described female terminal 10, for example, the higher the 0.2% proof stress of the base material is, the higher the springiness of the elastic contact piece 11 constituted as the spring portion is, and the higher the contact pressure applied to the embossed portion 11a that serves as the contact portion that makes electrical contact with the male terminal 30. As the contact pressure applied to the contact portion of the connection terminal is increased, a more stable state of low contact resistance can be maintained. As a result, resistance heat generation can be suppressed, softening and erosion of the base material due to resistance heat generation can be avoided more easily, and the connection terminal will have high heat resistance.

In particular, with a small connection terminal, as the width of a region where the contact portion is formed (the width of the mating female terminal 10 and the tab width of the male terminal 30), such as the spring portion, becomes smaller, and the plate thickness of the base material becomes smaller. Therefore, it is difficult to secure a sufficiently large spring load due to the contribution of the width and the thickness of the base material. Thus, a large elastic force needs to be secured as a material physical property itself of the copper alloy constituting the base material, and it is important to increase the 0.2% proof stress of the base material. A spring load sufficient for securing a contact pressure in the connection terminal can be secured by setting the 0.2% proof stress of this copper alloy to 620 MPa or higher. Contact pressure sufficient for the connection terminal can be easily secured even when the size of the connection terminal is reduced and the width of the region (tab width) where the contact portion is formed is set to 0.5 mm or smaller, and also even when the plate thickness of the base material is set to 0.20 mm or smaller. From the viewpoint of increasing the contact pressure, the 0.2% proof stress is more preferably 640 MPa or higher. Furthermore, the extent of direct influence on the contact pressure of the connection terminal is Young's modulus, and this copper alloy preferably has a Young's modulus of 100 GPa or higher.

On the other hand, if the 0.2% proof stress of the copper alloy is excessively high, it is difficult to shape the copper alloy. In particular, bendability tends to deteriorate. However, if the 0.2% proof stress of this copper alloy having a component composition in the above range is set to 700 MPa or lower, it is possible to avoid a situation where bendability required for forming the connection terminal cannot be secured due to excessive work hardening occurring. From the viewpoint of improving the bendability, the 0.2% proof stress is more preferably 680 MPa or lower.

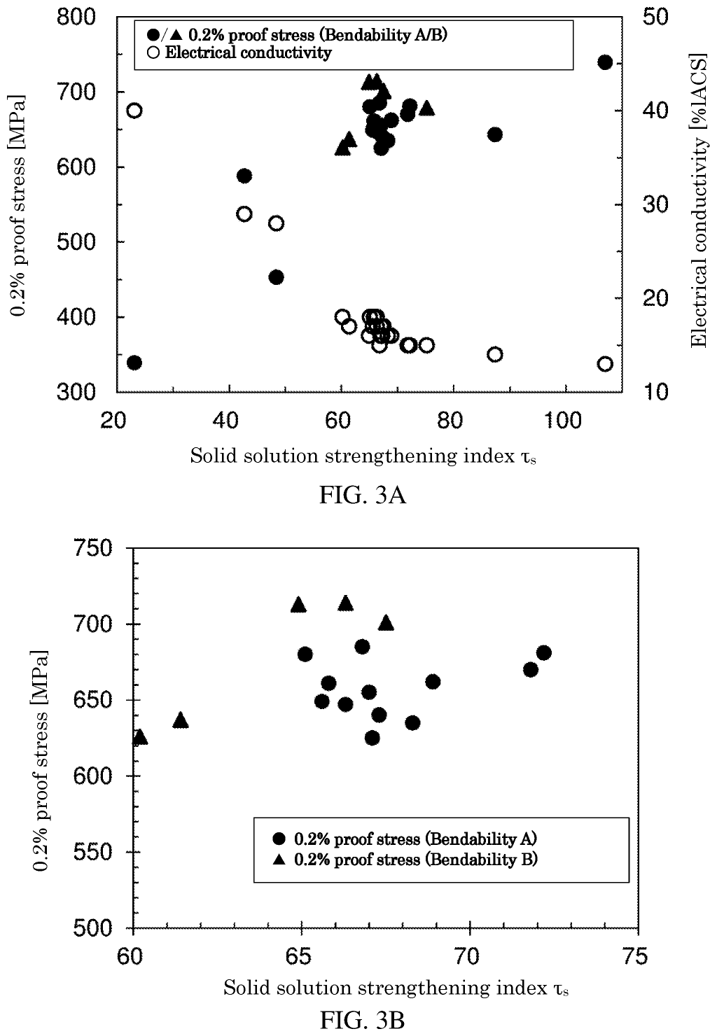

When the copper alloy has a 0.2% proof stress of 620 MPa or higher and 700 MPa or lower in this manner, it is possible to achieve both high contact pressure of connection terminals such as the female terminal 10 and bendability required for processing the terminals. The 0.2% proof stress can be adjusted by the component composition of the copper alloy. The 0.2% proof stress can be improved by increasing the amount of Zn, Sn, and Ni added within the above range, for example. Furthermore, the 0.2% proof stress can be adjusted by adjusting the ratio of the content of Zn, Sn, and Ni and controlling the value of the solid solution strengthening index τₛ. As will be described in the later examples with reference to FIGS. 3A and 3B, the larger the solid solution strengthening index τₛ is, the higher the 0.2% proof stress is. A 0.2% proof stress of 620 MPa or higher and 700 MPa or lower can be easily secured by satisfying 60≤τₛ≤75.

The 0.2% proof stress can also be adjusted depending on the conditions under which the copper alloy is manufactured. As the rolling amount of finish rolling is increased, the grain size decreases, and excessive work hardening also occurs, and the 0.2% proof stress can be improved, for example. In particular, in order to obtain high 0.2% proof stress, the rolling ratio of finish rolling is preferably set to 10% or higher, and more preferably set to 15% or higher. On the other hand, when the amount of work hardening is excessively large, ductility will decrease, and it will be difficult to secure bendability. Thus, with regard to the solid solution strengthening index τₛ, it is preferable to adjust the rolling amount of finish rolling such that the 0.2% proof stress is 700 MPa or lower, while 60≤τₛ≤75 is satisfied. In particular, if the rolling ratio is more than 50%, ductility will rapidly decrease, and thus the rolling ratio of finish rolling is preferably set to 40% or lower.

The copper alloy has a 0.2% proof stress of 620 MPa or higher and preferably has a 0.2% proof stress of 640 MPa or higher, and has 0.2% proof stress of 700 MPa or lower and preferably has a 0.2% proof stress of 680 MPa or lower, in the direction perpendicular to the rolling direction Dr. That is, the 0.2% proof stress measured by performing tensile testing along the direction perpendicular to the rolling direction Dr preferably has a value such as that described above. This is because the 0.2% proof stress can be easily controlled through rolling in the direction perpendicular to the rolling direction Dr. Also, as described above, with the connection terminal, when the bending direction D1 in which the spring portion such as the elastic contact piece 11 of the female terminal 10 is bent is set to be perpendicular to the rolling direction Dr, the copper alloy has a 0.2% proof stress of 620 MPa or higher in the direction perpendicular to the rolling direction Dr, and thus the spring load on the spring portion increases, and a large contact pressure tends to be applied to the contact portion. Meanwhile, when the 0.2% proof stress in the direction perpendicular to the rolling direction Dr is 700 MPa or lower, and thus, the spring portion can be easily formed through bending utilizing high bendability in this direction. The 0.2% proof stress of the copper alloy can be evaluated through tensile testing conforming to JIS Z 2241, for example.

(2) Electrical Conductivity

The copper alloy according to this form has an electrical conductivity of 15% IACS or higher and 20% IACS or lower. The higher the electrical conductivity of the copper alloy is, the smaller the resistance heat generation at the contact portion of the connection terminal is, and the less likely it is that the base material will soften or the connection terminal will be eroded through resistance heat generation. Because this copper alloy has a 0.2% proof stress of 620 MPa or higher and a large contact pressure can be secured at the contact portion of the connection terminal, if the copper alloy has an electrical conductivity of 15% IACS or higher, it is possible to sufficiently suppress resistance heat generation and to avoid softening of the base material and erosion of the connection terminal. Resistance heat generation occurring when the same amount of current flows increases as the size of the connection terminal is reduced but even when the width of the region where the contact portion is formed (tab width) is reduced to 0.5 mm or smaller, a small connection terminal such as the above is used in a signal system and only a small amount of current flows. Therefore, it is possible to sufficiently suppress resistance heat generation if the base material has an electrical conductivity of 15% IACS or higher. From the viewpoint of improving the resistance heat generation suppression effect, the electrical conductivity is more preferably 16% IACS or higher.

On the other hand, if the Zn content in the copper alloy is increased, the electrical conductivity will decrease. That is, the Zn content needs to be reduced in order to increase electrical conductivity. However, by keeping the electrical conductivity to 20% IACS or lower, it is possible to sufficiently increase the extent of solid solution strengthening and it is possible to add a sufficient amount of Zn to the copper alloy so as to sufficiently increase the extent of solid solution strengthening and to sufficiently exhibit the effect of reducing raw material costs.

As a result of the copper alloy having an electrical conductivity of 15% IACS or higher and 20% IACS or lower in this manner, it is possible to achieve both suppression of resistance heat generation at the contact portion of the connection terminal and allowance for addition of a sufficient amount of Zn thereto. The electrical conductivity can be mainly adjusted depending on the component composition of the copper alloy. The electrical conductivity increases by keeping the Sn content and the P content low as well as keeping the Zn content comparatively low. Also, as will be described in the later examples with reference to FIGS. 3A and 3B, the smaller the solid solution strengthening index τₛ is, the higher the electrical conductivity is. By satisfying 60≤τₛ≤75, an electrical conductivity of 15% IACS or higher and 20% IACS or lower can be easily secured. The electrical conductivity of the copper alloy can be measured using a four-terminal method, for example.

(3) Stress Relaxation Resistance

The copper alloy according to this form has high stress relaxation resistance due to a combination of Ni and P being added and the copper alloy comprising Ni—P-based precipitates. The fact that the solid solution strengthening index τₛ is suppressed to 75 or lower also has an effect on improving stress relaxation resistance. Because the copper alloy has high stress relaxation resistance, stress relaxation is unlikely to occur and a large elastic force can be maintained even if the copper alloy is exposed to a high temperature environment of 120° C. or higher, for example. Even when a connection terminal is used in a high temperature environment such as the vicinity of the engine compartment of an automobile, the spring load of the spring portion such as the elastic contact piece 11 of the female terminal 10 is maintained in a high state, and better electrical conductivity due to a large contact pressure can be maintained at the contact portion for a long period of time.

(4) Stress Corrosion Cracking Resistance

The copper alloy according to this form has high stress corrosion cracking resistance due to the Zn content being suppressed to 27 mass % or less and the effect of addition of Sn and Ni. Therefore, like the elastic contact piece 11 of the female terminal 10 that is mated with the male terminal 30, even when the connecting terminal is connected to a mating electrical connection member, the spring section is elastically deformed, and the connecting terminal is exposed to a corrosive environment while stress is applied, stress corrosion cracking is unlikely to occur.

[2] Copper Alloy According to Second Form

The copper alloy according to the first form described so far comprises Zn, Sn, Ni, and P in predetermined amount ranges, has a component composition such that the balance comprises Cu and inevitable impurities, and has predetermined ranges of 0.2% proof stress and electrical conductivity. Because the copper alloy comprises predetermined amounts of Zn, Sn, Ni, and P in the first form, the copper alloy has high stress resistance, bendability, and stress relaxation resistance.

However, with the copper alloy that comprises Zn, Sn, Ni, and P and whose balance comprises Cu and inevitable impurities, even when the content of each of Zn, Sn, Ni, and P does not necessarily satisfy a specific range specified in the first form, it is possible to obtain a copper alloy having high stress resistance, bendability, and stress relaxation resistance as long as the content of these additive elements satisfies a predetermined relationship. It is possible to form a connection terminal according to an embodiment of this disclosure using a copper alloy according to the second form as the copper alloy that has high stress resistance, bendability, and stress relaxation resistance due to the relationship between the contents of additive elements. The following briefly describes the copper alloy according to the second form.

The copper alloy according to the second form comprises Zn, Sn, Ni, and P, the balance comprises Cu and inevitable impurities, and the solid solution strengthening index τₛ satisfies 62≤τₛ≤75. Also, the copper alloy has a 0.2% proof stress of 620 MPa or higher and 700 MPa or lower, and has an electrical conductivity of 15% IACS or higher and 20% IACS or lower. Here, the solid solution strengthening index τₛ is defined by Formula (2).

$$[ Mathematical 3 ]$$

$${τ}_{s} = \frac{{164 [ Zn ]}^{\frac{2}{3}} + {858 [ Sn ]}^{\frac{2}{3}} + {45.6 [ Ni ]}^{\frac{2}{3}}}{{( 190 - 0.1 [ Zn ] - 0.9 [ Sn ] + 0.1 [ Ni ] )}^{\frac{2}{3}}} \qquad ( 2 )$$

where [Zn], [Sn], and [Ni] respectively represent the amounts of Zn, Sn, and Ni comprised in the copper alloy in units of mass %.

The solid solution strengthening index τₛ calculated using Formula (2) is the same as that used to define a relationship in which the Zn content, the Sn content, and the Ni content in the copper alloy according to the above first form are preferably satisfied. With the copper alloy according to the second form, it is possible to utilize the solid solution strengthening index τₛ as an index for forming a copper alloy having sufficiently large 0.2% proof stress and bendability and high electrical conductivity and stress relaxation resistance.

Even when the degree of processing is set by maintaining the solid solution strengthening index τₛ at 62 or higher such that the copper alloy has a 0.2% proof stress of 620 MPa or higher, it is possible to secure bendability to the extent that the base material can be formed into the shape of the connection terminal. From the viewpoint of further improving bendability, the solid solution strengthening index τₛ is more preferably 65 or higher. Note that, with regard to the copper alloy according to the first form, the lower limit of the solid solution strengthening index τₛ as a preferably example is 60, whereas, with regard to the copper alloy according to this second form, sufficiently high 0.2% proof stress and bendability can be achieved by setting the lower limit of the solid solution strengthening index τₛ to 62 without strictly limiting the individual contents of Zn, Sn, and Ni.

On the other hand, if the solid solution strengthening index τₛ is excessively large, it is difficult to maintain the electrical conductivity of the copper alloy at 15% IACS or higher. Also, stress relaxation resistance tends to decrease. In view of this, high electrical conductivity and stress relaxation resistance of the copper alloy can be maintained more easily by setting the solid solution strengthening index τₛ to 75 or lower. From the viewpoint of further improving these effects, the solid solution strengthening index τₛ is preferably 70 or lower.

When the solid solution strengthening index τₛ of the copper alloy satisfies 62≤τₛ≤75 in this manner, it is possible to achieve both the 0.2% proof stress required to achieve sufficiently stable electrical conductivity at the contact portion of the connection terminal and bendability required for forming the connection terminal. Also, the connection terminal has high electrical conductivity at which resistance heat generation can be suppressed and high stress relaxation resistance at which the connection terminal can withstand use in a high temperature environment.

The relationship between the P content and the content of other component elements in the copper alloy according to the second form is not specified. However, the P content preferably ranges from 0.01 mass % or more and 0.03 mass % or less.

Although details are not described, the same configuration as that of the copper alloy according to the first form is also applicable as a preferable configuration regarding the contents of the essential elements and optional additive elements and the properties of the copper alloy according to this second form. Also, the same effects as that of the above-described copper alloy according to the first form can be obtained by applying these configurations. If it is difficult to specify the contents of three types of additive elements Zn, Sn, and Ni only using the solid solution strengthening index τₛ, for example, the Zn content need only be set to 21 mass % or more and 27 mass % or less.

<Method for Manufacturing Connection Terminal>

Next, a method for manufacturing a connection terminal according to an embodiment of this disclosure will be described.

(Manufacturing of Copper Alloy)

First, a copper alloy in the form of a plate that serves as the base material of the connection terminal is manufactured. The copper alloy can be manufactured by performing the following steps (1) to (8) in the order mentioned below. A cycle of annealing in step (4) and cold rolling in step (5) may be performed multiple times. There is no particular limitation on specific conditions used when each step is performed, such as the treatment temperature, treatment time, processing ratio, and the like, and examples of treatment conditions will be described below. Also, examples of the dimensional change when copper alloy materials are successively processed are shown in parentheses. w represents the width of the copper alloy material, t represents the thickness, and L represents the length.

(1) Melt casting (100 mm w×30 mm t×200 mm L)

(2) Hot rolling 800° C. to 900° C.×1 hour (6 mm t)

(3) Cold rolling (1.0 mm t)

(4) Annealing 500° C. to 600° C.×1 hour

(5) Cold rolling

(6) Annealing 400° C. to 500° C.×1 hour (grain size of 2.0 to 5.0 μm)

(7) Cold rolling processing ratio 10% to 40% (0.2 mm t)

(8) Stress relief annealing 200° C. to 300° C.×1 hour

Manufacturing of Connection Terminal

Next, a connection terminal is manufactured using a plate member made of the copper alloy manufactured as described above as a base material. Prior to processing performed on the connection terminal, a coating layer such as a tin plating layer may be formed on the surface of the base material as appropriate. Then, it is possible to manufacture the connection terminal such as the female terminal 10 by forming the plate member into a terminal shape through press-punching, bending, and the like.

When press-punching or bending is performed on the base material, the direction of the terminal shape may be preferably set with respect to the directions of the base material such that the spring portion of the connection terminal is formed by bending the base material in the direction perpendicular to the rolling direction Dr of the base material. In the case of the above female terminal 10, when press-punching is performed, the direction in which the terminal shape is punched need only be set with respect to the direction of the base material such that the direction in which a portion that is to be the elastic contact piece 11 extends from a portion that is to be the bottom surface 13a of the pressing portion 13 is perpendicular to the rolling direction Dr. Then, when bending is performed, the portion that is to be the elastic contact piece 11 need only be bent with respect to the portion that is to be the bottom surface 13a of the pressing portion 13 in the direction perpendicular to the rolling direction Dr. A high spring load can be obtained in the spring portion and bendability can be ensured by manufacturing the connection terminal such that the bending direction D1 of the spring portion is perpendicular to the rolling direction Dr of the base material in this manner.

### Examples

The following describes examples. Note that the present invention is not limited by these examples. In the following, each evaluation was performed in an atmosphere at room temperature, unless otherwise specified.

[Test Method]

### (1) Production of Samples

Copper alloys that contained elements shown in Table 1 and whose balance comprises Cu and inevitable impurities were produced as plate members with a thickness of 0.2 mm, and the obtained samples were used as samples 1 to 12 and samples 101 to 111. The copper alloys were manufactured through (1) melt casting, (2) hot rolling, (3) cold rolling, (4) annealing, (5) cold rolling, (6) annealing, (7) cold rolling, and (8) stress relief annealing in the stated order. The grain size and mechanical properties of each sample were adjusted by adjusting the component composition thereof, and rolling conditions and heat treatment conditions in the manufacturing process.

(2) Evaluation of Mechanical Properties and Electrical Conductivity

Tensile testing conforming to JIS Z 2241 was performed on each copper alloy in an atmosphere at room temperature, and the 0.2% proof stress was evaluated from a stress-strain curve. Tensile testing was performed using a JIS 13B test piece in the direction perpendicular to the rolling direction of the copper alloy. Furthermore, the electrical conductivity was measured using a four-terminal method.

(3) Evaluation of Grain Size

A cross-section of each copper alloy was observed from the rolling direction using a scanning electron microscope (SEM). Also, an average value of the equivalent circle diameters of crystal grains was estimated as the average grain size.

(4) Evaluation on Connection Terminal

A female terminal with a tab width of 0.5 mm was produced using the copper alloy of each sample. When press-punching and bending for forming the copper alloy into a terminal shape are performed, the direction perpendicular to the rolling direction of the copper alloy was set to a direction in which the elastic contact piece of the female terminal was bent. The following properties were evaluated using the produced connection terminal.

Bendability

A portion of the connection terminal having a 180 degree bend where the elastic contact piece was folded back from the bottom surface of the pressing portion having a rectangular tubular shape, and a portion having an 90 degree bend on a wall surface of the pressing portion having the rectangular tubular shape were observed through high-resolution X-ray computed tomography (CT). When no crack formed in any portion, the sample was evaluated as having high bendability (A). On the other hand, when a crack formed in at least one of the portions, the sample was evaluated as having insufficient bendability (B).

Conductivity

A wire was connected to the connection terminal and power was supplied, and an increase in the temperature of the connection terminal to which power was being supplied was measured using a thermocouple fixed in contact with the crimping portion of the terminal (a portion where the wire was connected to the connection terminal through crimping). If an increase in the temperature when a rated current was applied and stabilized did not exceed a range of 30° C., the sample was evaluated as having high conductivity (A). On the other hand, if an increase in the temperature exceeded the above range, the sample was evaluated as having insufficient conductivity (B).

Spring Load

The load of the elastic contact piece applied to the contact portion in the connection terminal was measured using a universal testing machine with a load cell. If a load set at the time of design was obtained, the sample was evaluated as having a sufficient spring load (A). On the other hand, if a measured value was smaller than the load set at the time of design, the sample was evaluated as having an insufficient spring load (B).

Stress Relaxation Resistance

The plate member of the copper alloy before being formed into the connection terminal was supported by a jig for supporting both ends, and was kept at 120° C. while stress with the magnitude of 80% of the 0.2% proof stress was being applied. The stress unloaded while the test piece was held was measured by measuring the amount of dimensional change in the tested test piece. When less than 20% of the applied stress was unloaded, the sample was evaluated as having high stress relaxation resistance (A). When 20% or higher of the applied stress was unloaded, the sample was evaluated as having insufficient stress relaxation resistance (B).

Stress Corrosion Cracking Resistance

The sample was sealed in a container in which ammonia water with a concentration of 10 mass % was placed at the bottom thereof in a state where the male terminal was mated with the produced female terminal. The pair of mated terminals were held at a position higher than the liquid surface of the ammonia water such that the pair of terminals was not in direct contact with the ammonia water in the container. The pair of terminals was removed from the container after 120 hours, and the female terminal was observed visually. If no crack formed, the sample was evaluated as having particularly high stress corrosion cracking resistance (A+). Even when a crack formed, if a contact load was 80% or higher of the initial value, the sample was evaluated as having high stress corrosion cracking resistance (A). If a crack formed and the contact load was less than 80% of the initial value, the sample was evaluated as having insufficient stress corrosion cracking resistance (B).

[Results of Testing]

Table 1 shows results of measurements of the solid solution strengthening index τₛ calculated based on the component composition and the Formula (2) above, the average grain size, the 0.2% proof stress, and the electrical conductivity of the copper alloys according to the samples 1 to 12 and samples 101 to 111, and the results of various evaluations. Also, FIG. 3A shows the relationship of the solid solution strengthening index with the 0.2% proof stress and the electrical conductivity. FIG. 3B shows an enlarged view of the portion shown in FIG. 3A.

TABLE 1

| | | | | | Solid | Ave. | 0.2% | | | | | | Stress |
|---|---|---|---|---|---|---|---|---|---|---|---|---|---|
| | Additive Elements | | | | solution | Grain | Proof | Electrical | | Con- | | Stress | Corrosion |
| Sample | [mass %] | | | | strengthening | Size | Stress | Conductivity | Bend- | duc- | Spring | Relaxation | Cracking |
| No. | Zn | Sn | Ni | P | index τ_{S} | [μm] | [MPa] | [% IACS] | ability | tivity | Load | Resistance | Resistance |
| 1 | 22 | 0.9 | 2.5 | 0.02 | 66.3 | 2.1 | 647 | 18 | A | A | A | A | A+ |
| 2 | 24 | 0.8 | 3.2 | 0.02 | 67.3 | 3.9 | 640 | 16 | A | A | A | A | A+ |
| 3 | 24.5 | 0.9 | 3.3 | 0.02 | 68.9 | 3.2 | 662 | 16 | A | A | A | A | A+ |
| 4 | 25 | 0.8 | 3 | 0.02 | 68.3 | 3.6 | 635 | 16 | A | A | A | A | A+ |
| 5 | 22 | 0.9 | 3.7 | 0.01 | 67.1 | 2.5 | 625 | 17 | A | A | A | A | A+ |
| 6 | 27 | 0.6 | 3.5 | 0.02 | 67 | 3 | 655 | 16 | A | A | A | A | A+ |
| 7 | 26 | 0.9 | 3.7 | 0.01 | 71.8 | 3.5 | 670 | 15 | A | A | A | A | A+ |
| 8 | 21 | 0.9 | 3.2 | 0.02 | 65.6 | 3.1 | 649 | 17 | A | A | A | A | A+ |
| 9 | 27 | 0.9 | 2.5 | 0.02 | 72.2 | 2.3 | 681 | 15 | A | A | A | A | A |
| 10 | 26 | 0.6 | 3.5 | 0.01 | 65.8 | 2.5 | 661 | 18 | A | A | A | A | A+ |
| 11 | 25 | 0.7 | 3.7 | 0.02 | 66.8 | 2 | 685 | 15 | A | A | A | A | A+ |
| 12 | 21 | 0.9 | 2.5 | 0.02 | 65.1 | 2.5 | 680 | 18 | A | A | A | A | A+ |
| 101 | 30 | 0 | 0 | 0 | 48.4 | 4.7 | 453 | 28 | A | A | B | B | B |
| 102 | 0 | 6 | 0 | 0.2 | 87.4 | 4.5 | 643 | 14 | A | B | A | B | B |
| 103 | 10 | 0 | 0 | 0 | 23.1 | 3.3 | 339 | 40 | A | A | B | B | B |
| 104 | 0 | 8 | 0 | 0.2 | 107 | 5 | 739 | 13 | A | B | A | B | B |
| 105 | 10 | 0.6 | 0.6 | 0.2 | 42.7 | 3.1 | 588 | 29 | A | A | B | A | A+ |
| 106 | 22 | 0.6 | 2 | 0.02 | 60.2 | 4.7 | 626 | 18 | B | A | B | A | A+ |
| 107 | 29 | 0.9 | 3.7 | 0.01 | 75.2 | 4 | 679 | 15 | A | B | A | B | B |
| 108 | 23 | 0.6 | 2 | 0.02 | 61.4 | 2.5 | 637 | 17 | B | A | B | B | A+ |
| 109 | 22 | 0.9 | 3.5 | 0.02 | 66.3 | 2 | 714 | 17 | B | A | B | A | A+ |
| 110 | 24 | 0.8 | 3.5 | 0.01 | 67.5 | 2.4 | 701 | 17 | B | A | B | A | A+ |
| 111 | 27 | 0.5 | 3.7 | 0.02 | 64.9 | 2.2 | 713 | 16 | B | A | B | A | A+ |

(1) Relationship Between Component Composition and Properties

According to Table 1, the samples 1 to 12 were made of a copper alloy comprising 21 mass %≤Zn≤27 mass o, 0.6 mass %≤Sn≤0.9 mass %, 2.5 mass %≤Ni≤3.7 mass %, and 0.01 mass %≤P≤0.03 mass %. Furthermore, the copper alloy had a 0.2% proof stress of 620 MPa or higher and 700 MPa or lower, and had an electrical conductivity of 15% IACS or higher and 20% IACS or lower, as physical properties.

Because the connection terminals produced using the copper alloys according to the samples 1 to 12 all had the component compositions and physical properties described above, those connection terminals all had high bendability, conductivity, spring load, stress relaxation resistance, and stress corrosion cracking resistance. Note that the reason why the stress corrosion cracking resistance of the sample 9 was not as high as that of the other samples is conceivably because the Zn content was high and the Ni content was low, and thus the stacking-fault energy was lower than that of the other samples and stress tended to be concentrated. Also, the samples 1 to 12 all had an average grain size of 2.0 μm or larger and 5.0 μm or smaller.

On the other hand, the samples 101 to 111 all did not satisfy the above predetermined ranges for at least one of the component composition, 0.2% proof stress and electrical conductivity. Consequently, the samples 101 to 111 did not achieve sufficiently high evaluation results as connection terminals, with regard to at least one of the bendability, conductivity, spring load, stress relaxation resistance, and stress corrosion cracking resistance.

The samples 101 to 104 contained only one of the three types of additive elements Zn, Sn, and Ni. The sample 101 corresponded to brass, and the samples 102 and 104 corresponded to phosphor bronze. The samples 101 to 104 did not achieve sufficiently high evaluation results as the connection terminals as a consequence of comprising only one of the above additive elements. The samples 101 and 103 had excessively high electrical conductivity as a consequence of not comprising Sn or Ni, while the 0.2% proof stress could not be improved to 620 MPa or higher, and the spring load of the connection terminal was also insufficient. Although the samples 102 and 104 contained only Sn out of the three types of additive elements, the Sn content was much higher than that in the samples 1 to 12. Consequently, although a high 0.2% proof stress was obtained, and the spring load of the connection terminal was also high, the electrical conductivity thereof did not reach 15% IACS, and the conductivity of the connection terminal was also insufficient. All of the samples 101 to 104 had insufficient stress relaxation resistance and insufficient stress corrosion cracking resistance.

Although the samples 105 to 108 contained the three types of additive elements Zn, Sn, and Ni, and P, the content of at least one of the three types of additive elements was not within the above predetermined range. Out of these samples, the amounts of Zn, Sn, and Ni contained in the sample 105 were all significantly lower than the above range of the samples 1 to 12, and thus the 0.2% proof stress could not be improved to 620 MPa or higher, and the spring load of the connection terminal was also insufficient. The stress relaxation resistance was also insufficient. The samples 106 and 108 contained sufficient amounts of Zn and Sn, whereas the Ni content was low. Consequently, at least bendability and spring load were not sufficiently obtained. Because bendability was low, spring load decreased due to cracks in the bent base material. Note that, although the samples 106 and 108 had similar component compositions, the sample 108 had a higher rolling ratio of finish rolling (cold rolling in the above process (7)), and thus had a higher 0.2% proof stress. The sample 107 contained excessive Zn. Consequently, the electrical conductivity was comparatively low, and the conductivity of the connection terminal was insufficient. The sample 107 had low stress relaxation resistance and low stress corrosion cracking resistance.

Although the samples 109 to 111 all contained the component elements in amounts within the above predetermined ranges, the 0.2% proof stress thereof was more than 700 MPa. The reason for the 0.2% proof stress being high is that the rolling ratio of finish rolling was set to 50% or higher. Due to a high rolling ratio and excessive work hardening, all of the samples had insufficient bendability. Furthermore, a sufficient spring load was not obtained as a consequence of cracks forming in the base material during bending.

As described above, it was shown that, by forming a connection terminal using, as a base material, a copper alloy that contained the predetermined amounts of Zn, Sn, Ni, and P and whose balance comprises Cu and inevitable impurities, and that had a 0.2% proof stress and electrical conductivity in predetermined ranges, a connection terminal have good properties such as bendability, conductivity, spring load, stress relaxation resistance, and stress corrosion cracking resistance is obtained.

(2) Relationship of Solid Solution Strengthening Index τₛ with 0.2% Proof Stress and Electrical Conductivity

FIG. 3A shows the results of Table 1 obtained for the samples 1 to 12 and the samples 101 to 111, and the relationship of the solid solution strengthening index τₛ with the 0.2% proof stress and the electrical conductivity of the samples. In FIG. 3A, the solid solution strengthening index τₛ calculated based on the component composition is shown on the horizontal axis. Also, the 0.2% proof stress is shown on a left vertical axis. In the bendability evaluation tests whose results are shown in Table 1, a sample (A) with high bendability is indicated by a black circle, and a sample (B) with insufficient bendability is indicated by a triangle. On the other hand, the electrical conductivity is shown on a right vertical axis, using a white circle. FIG. 3B is an enlarged view of the 0.2% proof stress shown in FIG. 3A with a solid solution strengthening index τₛ of 60 to 75.

According to FIGS. 3A and 3B, first, there is a tendency that the smaller the solid solution strengthening index τₛ is, the higher the electrical conductivity is. On the other hand, the 0.2% proof stress tends to substantially increase as the solid solution strengthening index τₛ increases. Also, even when the solid solution strengthening index τₛ is about the same, if the 0.2% proof stress is 700 MPa or lower, high bendability can be obtained, whereas when the 0.2% proof stress is more than 700 MPa, sufficient bendability is not obtained. As shown in FIG. 3B, if the content of each component element is within a predetermined range, by keeping the solid solution strengthening index τₛ in the range of 60≤τₛ≤75 while setting the 0.2% proof stress to 620 MPa or higher and 700 MPa or lower, it is possible to achieve high bendability and 0.2% proof stress for providing a sufficient spring load.

According to FIG. 3B, even though there are regions in which the 0.2% proof stress is in a range of 620 MPa or higher and 700 MPa or lower at the positions τₛ=60.2 and τₛ=61.4, there are data points at which sufficient bendability is not obtained. These data points correspond to the samples 106 and 108 in Table 1. Even when the amounts of the component elements contained in the copper alloy are not specified, by specifying the solid solution strengthening index τₛ in the range of 62≤τₛ≤75, it is possible to form a connection terminal by discriminating copper alloys having 0.2% proof stress and electrical conductivity in the above predetermined ranges and having sufficient bendability from copper alloys that have 0.2% proof stress in a predetermined range of 620 MPa or higher and 700 MPa or lower but cannot obtain sufficient bendability.

Although embodiments of the present invention were described in detail above, the present invention is not limited to the above-described embodiments, and various modifications can be made without departing from the gist of the present invention.

### LIST OF REFERENCE NUMERALS

10 Female terminal
11 Elastic contact piece (spring portion)
11a Embossed portion (contact portion)
12 Inner facing contact surface
13 Pressing portion
13a Bottom surface of pressing portion
30 Male terminal
D1 Bending direction
Dr Rolling direction

1. A connection terminal comprising a copper alloy as a base material, the copper alloy comprising:
Zn in an amount of 21 mass % or more and 27 mass % or less;
Sn in an amount of 0.6 mass % or more and 0.9 mass % or less;
Ni in an amount of 2.5 mass % or more and 3.7 mass % or less; and
P in an amount of 0.01 mass % or more and 0.03 mass % or less, and
the balance being Cu and inevitable impurities,
wherein the copper alloy has:
a 0.2% proof stress of 620 MPa or higher and 700 MPa or lower; and
an electrical conductivity of 15% IACS or higher and 20% IACS or lower.

2. The connection terminal according to claim 1,
wherein a solid solution strengthening index τₛ calculated by a formula below satisfies 60≤τₛ≤75,
τₛ=(164[Zn]^{2/3}+858[Sn]^{2/3}+45.6[Ni]^{2/3})/(190−0.1[Zn]−0.9[Sn]+0.1[Ni])^{2/3},
where [Zn], [Sn], and [Ni] represent the amount of Zn, Sn, and Ni in the base material in mass %, respectively.

3. The connection terminal according to claim 1,
wherein the copper alloy has an average grain size of 2.0 μm or larger and 5.0 μm or smaller.

4. The connection terminal according to claim 1,
wherein the copper alloy further comprises Fe in an amount of 0.02 mass % or less.

5. The connection terminal according to claim 1,
wherein the copper alloy further comprises at least one selected from the group consisting of Co, Cr, Zr, Ti, Mn, and V in a total amount of 0.1 mass % or less.

6. The connection terminal according to claim 1,
wherein the copper alloy has the 0.2% proof stress of 620 MPa or higher and 700 MPa or lower in a direction perpendicular to a rolling direction.

7. The connection terminal according to claim 1, comprising:
a spring portion where the copper alloy in the form of a place is bent in a direction perpendicular to a rolling direction of the copper alloy, in a region that includes a contact portion that makes electrical contact with a counterpart electrical contact portion.

8. The connection terminal according to claim 7,
wherein the connection terminal is a female terminal.

9. The connection terminal according to claim 1,
wherein a tab width, which is defined as the width of a tab of a mating counterpart male terminal if the connection terminal is a female terminal, and which is defined as the width of the tab of a male terminal if the connection terminal is the male terminal, is 0.5 mm or smaller.

10. The connection terminal according to claim 1,
wherein the copper alloy constitutes the connection terminal in the form of a plate with a thickness of 0.20 mm or smaller.
